(19) United States
(12) Patent Application Publication
(10) Pub. No.: US 2004/0031676 A1
(43) Pub. Date: Feb. 19, 2004

(54) Corona discharge cells and methods of use

(76) Inventors: John Lionel Brauer, Queensland (AU); David Kerin Leigh Noller, Queensland (AU)

Correspondence Address: Don W Bulson, Renner Otto Boisselle & Sklar, 1621 Euclid Avenue, 19th Floor, Cleveland, OH, 44115, US

(21) Appl. No.: 10/362,043

(22) PCT Filed: Aug. 17, 2001
(86) PCT No.: PCT/AU01/01026

(30) Foreign Application Priority Data
Aug. 18, 2000 (AU) PQ 9539
Nov. 20, 2000 (AU) PR 1566
May 30, 2001 (AU) PR 5347

(51) Int. Cl. B01J 19/08; B01J 19/12

(52) U.S. Cl. 204/176; 422/186.04; 422/186.07

(57) ABSTRACT

Corona discharge cells for the production of ozone are respectively constructed of inner electrodes fabricated from metal bar, a dielectric sleeve and outer electrodes. Spacers and/or sealing rings isolate a corona discharge producing region from ambient conditions. The surfaces of the inner electrodes can be roughed to enhance ozone production within the corona discharge producing region.

### TECHNICAL FIELD

This invention relates to corona discharge cells for generating ozone.

### BACKGROUND ART

During the manufacture of Ozone by corona discharge a corona is generated for ozone production by applying an electrical current across two metallic electrodes separated by a dielectric insulator and an air gap.

The electrical current will not arc between the electrodes because of the dielectric and the air gap. Instead, an energized corona develops in the interstitial space between the electrodes, which is characterised by a deep blue or violet glow.

Ozone is produced by passing oxygen or air through this electrical field wherein a certain percentage of the oxygen molecules dissociate then recombine as ozone.

In our international patent application no. PCT/AU00/00617 entitled OZONE GENERATING APPARATUS we have described a corona discharge cell comprising an elongate inner electrode in the form of a metal rod, and elongate dielectric sleeve coaxially mounted with the inner electrode and an elongate outer electrode mounted coaxially with the dielectric sleeve.

In some environments such as in cool storage rooms for fruit and vegetables having ozone generators the corona discharge process can be adversely affected by moisture and cold.

Corona discharge ozone cells generally provide more constant ozone output than do UV ozone producing lamps.

Ozone producing ultra violet lamps can deteriorate quite quickly with ozone output declining quite rapidly and corona discharge cells are preferable and allow manufacturers to better develop protocols for ozone concentrations for various fruits and vegetables treatments, however, their use is dependent upon the development of corona discharge cells that can withstand the cold and moisture when placed in cool storage environments.

When using the corona discharge ozone generators to produce ozone air in cool, moist environments, suitable cold and moisture resistant electronic equipment is required.

The electronic control board, transformer, connections, etc all need to be suitably designed and insulated so they will function under these conditions.

The corona cell assembly itself, over which air is blown by the generator fan to generate ozone, has to be cold-resistant and moisture-resistant so that it functions effectively under these conditions and continues to produce adequate levels of ozone.

In addition, when an ozone generator is controlled by a timer or ozone monitor, the entire electrical assembly including the generating cell will become cold during the time the machine is switched off.

The cell needs to respond quickly when the generator is turned on and recover to ensure a normal corona is again established to produce ozone.

Cold adds current load and as a unit warms up condensation will occur on the outer electrode and on any exposed parts of the dielectric to add more current load, as well as providing an opportunity for arcing to occur.

If arcing occurs, the cell can break down and fail.

Electricity will follow moisture so any droplets of moisture that form on the outer electrode or dielectric may allow arcing to travel from the outer electrode along the dielectric and try to reach the inner electrode or enclosure wall.

If this occurs, a short can occur resulting in the cell breaking down.

Moisture can also be carried by the generator fan and possibly get between the inner electrode and the inside face of the dielectric.

When the dielectric tubing from off-the-shelf is used the inside dimension is not always uniform.

The inner electrode also may not be perfectly uniform in its diameter.

As a result, minute gaps are possible between these two components when the cylindrical dielectric is placed over the inner electrode.

This situation can lead to leakage and cell failure.

When an ozone generator that generates ozone from air is installed in a confined space to either treat the air or a product with ozone, any residual ozone will be drawn through the ozone generator causing corrosion to certain generator components, particularly electronic components, resulting in malfunction and short working life.

One option is to totally enclose the electronic power board within the generator to safeguard it from residual ozone.

Other electronic components such as power sockets, fuse holders etc can be coated with a suitable epoxy to protect them from ozone.

Standard fans have limited ozone resistance.

Ensuring all generator components are corrosion and ozone resistant can be expensive and render the generator unaffordable.

Additionally when a corona discharge ozone generation cell is used to produce medium to high levels of ozone from air undesirable nitrogen byproducts can form which can also affect generator components.

This can be more apparent when such a generator is installed in a cold storage room where moisture levels can be high.

It is an object of the present invention to provide a corona discharge apparatus for generating ozone in air which will operate efficiently in dry as well as cold and wet environments.

Further objects and advantages of the present invention will become apparent from the ensuing description which is given by way of example.

### DISCLOSURE OF INVENTION

According to the present invention there is provided a corona discharge apparatus comprising

(a) an elongate inner electrode,

(b) an elongate dielectric sleeve mounted on the inner electrode,

(c) an elongate outer electrode mounted on the dielectric sleeve, and

(d) a pair of spaced sealing members between the inner electrode and the dielectric which define an ozone-producing region over which the outer electrode extends.

The inner electrode can be a metal bar.

The inner electrode can be provided with an internal bore which extends substantially throughout the ozone producing region.

The inner electrode can be provided with circular spaced circular grooves in which the sealing members are located.

The sealing members can comprise resilient O-ring seals.

The inner bore can be sealed off.

The outer surface of the inner electrode can be provided with a rough finish created by knurling, chip forming, multistart threads or equivalent processes.

The inner electrode, dielectric sleeve and the outer electrode can be cylindrical.

The dielectric sleeve can be open at one end and crimped at another end.

The present invention also provides a method of generating ozone in a controlled environment comprising the steps of positioning corona discharge apparatus as aforesaid within the controlled environment and providing a connecting power source for the apparatus in a position remote from the controlled environment.

According to a further aspect of the present invention there is provided corona discharge apparatus comprising;

(a) an elongate inner electrode,

(b) an elongate dielectric sleeve mounted on the inner electrode,

(c) an elongate outer electrode mounted on the dielectric sleeve,

(d) a pair of peripheral spacer members extending from the inner electrode which define an ozone producing zone over which the outer electrode extends,

(e) an air space between the inner electrode and the dielectric created by the spacers, and

(f) hollow bores extending from respective ends of the inner electrode and an outlet from each of the bores into the air space.

The outer surface of the inner electrode between the outlets can be roughened.

At least one end of the inner electrode outside the ozone producing zone can be provided with an external thread to facilitate fixture of the apparatus to a supporting wall.

The spacers can be provided in the form of resilient O-rings and/or flanges.

The outer surfaces of the inner electrode outside the ozone producing zone can be provided with cooling fins created by threads or fluting.

The inner electrode, dielectric sleeve and the outer electrode can be cylindrical.

The inner electrode can extend throughout and beyond both ends of the dielectric sleeve.

The roughed surface can be created by knurling, chip forming, multistart threads or equivalent processes.

Ambient air, dried air or oxygen can be used as the feed gas which is pumped or sucked through the apparatus to produce ozone.

The apparatus may be powered by a control board with a transformer.

While this apparatus is ideal for providing ozone in water treatment systems, it can also be used to provide ozone for air treatment.

When used for air treatment the feed gas is pushed through the apparatus and the produced airborne ozone is simply ducted into the space to be treated.

In water treatment usually a venturi will draw the feed gas through the apparatus, making ozone, then injecting and dissolving the ozone into the water stream.

The apparatus can be made from a solid stainless steel rod. preferably 316 grade to offer ozone resistance.

A threaded section which permits two nuts to act as a mounting can be provided.

Two o-rings, made of suitable ozone resistant material, such as viton or silicone, act as air gap controls ensuring the desired air gap between the stainless steel inner electrode and the dielectric is constant throughout the length of the apparatus.

The dielectric tube may be any suitable material such as quartz, ceramic or borosilicate glass (Pyrex).

When borosilicate glass tubing is used as the dielectric, its inside dimension is not always constant.

Since the o-rings compress they counteract this variation in the glass and also provide an airtight seal of the reaction chamber stopping any ozone from escaping.

The o-ring groove is designed so the o-ring is held in place while providing the desired air gap.

The size of the o-ring and the depth and width of the groove produce the required air gap.

If the o-rings are positioned within the reaction chamber itself, over a period of constant use with high concentrations of ozone, the o-rings may deteriorate allowing some ozone leakage and also compromising the precision of the air gap resulting in lower production.

The o-rings can be moved outside the reaction chamber itself, and can be protected somewhat by a bulkhead/flange that is sized to marry as closely as possible with the inside of the dielectric tube so as to be air tight as possible and to stop ozone leakage to the o-ring as much as possible.

Immediately behind the o-ring can be another bulkhead/flange which again is designed to marry as closely as possible with the inside of the dielectric tube so as to stop ozone escaping.

Immediately behind the second bulkhead/flange a groove can be provided.

When the entire cell is assembled, a suitable sealant, such as a silicone based sealant, is inserted into the groove between the inner stainless steel electrode and the dielectric completely sealing the cell chamber. Both ends are sealed.

When cured, the sealant also maintains the air gap between the inner electrode and the dielectric.

If the o-rings ever do disintegrate, the sealant will maintain the integrity of the air gap allowing for a much longer life of the apparatus.

Using the o-rings also helps with the assembling of the apparatus since they provide the exact air gap so applying the sealant at each end is a simple process and does not require separate jigging.

A feature of this apparatus is that the length of the inner electrode can be extended allowing for a section of thread and then the end section can act as a fitting for the ducting tube to be attached.

Two nuts can then act as a mounting so the tube can be firmly mounted to the wall of an enclosure, negating the need for a separate bulkhead fitting with a tube fitting.

The outer electrode may be made of suitable conductive material such as stainless steel sheeting or aluminium foil rolled into a cylindrical shape.

Ozone resistant rings may be at both ends will keep tension on the outer electrode so it keeps contact with the dielectric and so it does not shift along the dielectric.

### BRIEF DESCRIPTION OF THE DRAWINGS

Aspects of the present invention will now be described by way of example only with reference to the accompanying drawings in which;

FIG. 1 is a sectional view of a corona discharge apparatus according to one aspect of the present invention,

FIGS. 2, 3 and 4 are sectional and end view drawings of a corona discharge apparatus according to other aspects of the present invention, and

FIGS. 5, 6 and 7 are sectional drawings of further possible forms of corona discharge apparatus according to the present invention, and

FIGS. 8, 9, and 10 are illustrations of an ozone generating installation for a controlled environment e.g., a coolstore, and

FIG. 11 is a side view of a further form of corona discharge apparatus according to the present invention, and

FIGS. 12 and 13 are sectional drawings of the corona discharge apparatus of FIG. 11, taken at XII:XII and XIII:XIII respectively,

FIG. 14 is a side view of a discharge apparatus of FIG. 3 shown installed in a console.

FIGS. 15 and 16 are plan and side views of a heat disapation device for the apparatus of the present invention.

FIG. 17 is a plan view of an inner electrode according to the present invention showing a roughed outer surface portion, and

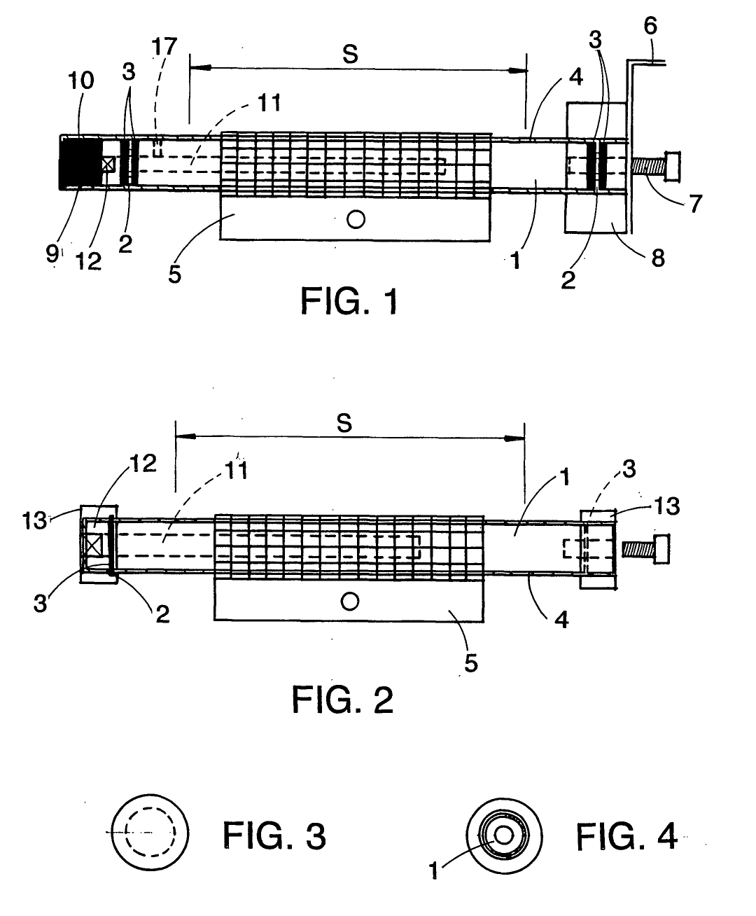

With respect firstly to FIGS. 1 to 10 of the drawings typically a corona discharge cell according to the present invention can comprise an inner electrode 1 having spaced peripheral groves 2 therein, which define a corona discharge zone S.

Resilient seals 3 are provided within the grooves 2.

A dielectric sleeve 4 is mounted coaxially with the inner electrode 1 and an outer electrode 5 mounted is on the sleeve 4.

The outer electrode 5 can be constructed similarly to the electrodes described in our aforementioned International patent application.

Free ends of the sheeting are crimped and the sheeting tensioned using an angle shaped metal member which is collapsed so that the free ends of the metal member grip the free ends of the sheet and apply a uniform tension to the sheeting. The metal member provides means for attaching a power supply.

A mounting bracket 6 (shown in FIG. 1 only) is fixed to one end of the cell enables the cell to be mounted within the housing of an ozone generating apparatus (not shown).

A threaded shank 7 passes through a limb of the bracket 6 and provides for connection to a power source.

The outer electrode 5 also provides for an electrical power connection.

An insulating collar 8 outside the discharge zone S abuts the bracket 6.

The free end 9 of the dielectric sleeve 4 extends beyond the end of the inner electrode 1 and the interiors of the extended portion are filled with a sealant 10.

In some instances the sealant may be protected by a closed end or cap.

In the arrangement illustrated the seals 3 isolate the discharge zone S and prevent leakage into the zone and the sealant 10 isolates the discharge zone and seals it off from ambient conditions.

The inner electrode can be provided with a bore 11 or may be a hollow metal tube (not shown).

Where the inner electrode is provided with a bore 11 the entry 12 to the bore may be provided with a plug which will prevent the sealant being drawn into the bore.

Whilst the corona discharge apparatus of FIGS. 1 to 5 vary in detail in all cases, the apparatus isolates the inner electrodes 1 from ambient conditions.

In FIG. 1 a sealant 10, seals 3, and plugs 12 isolate the critical inner electrode region.

In FIG. 2 insulating collars 13 are used on the ends of the apparatus.

In some instances, the dielectric sleeve 4 material may completely enclose the inner electrode so that no electric charge can travel along the dielectric to the ends of the inner electrode 1.

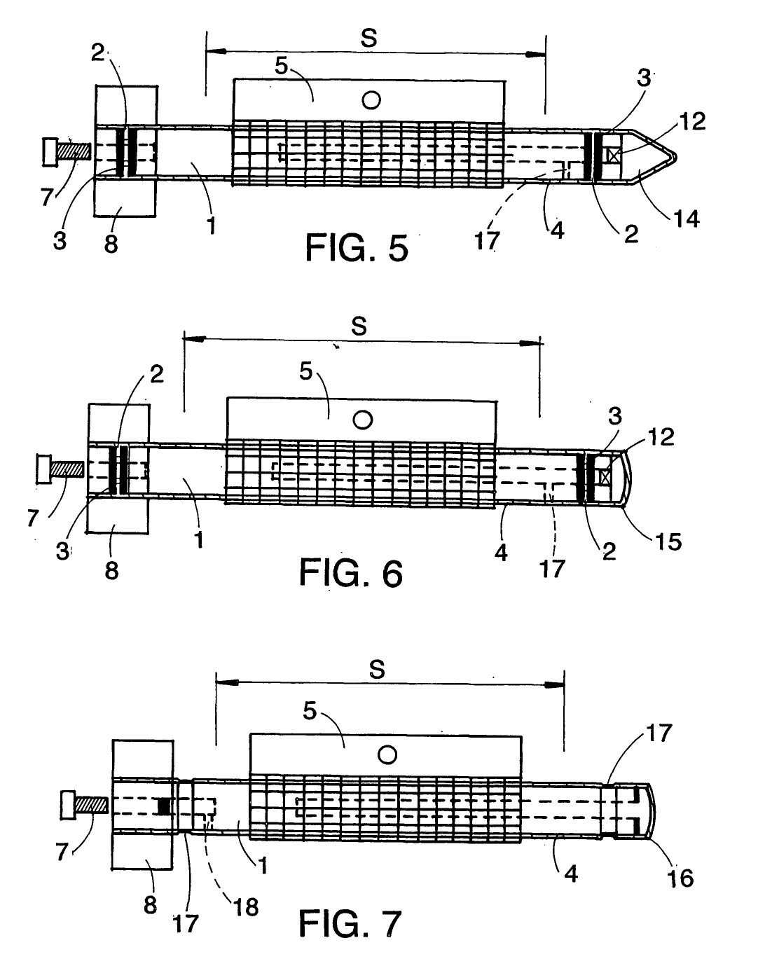

In FIG. 5, the free end 14 at the dielectric sleeve 4 is fashioned into a conical shape and completely seals off the end.

In FIG. 6, the free end 15 of the dielectric sleeve 4 is dome-shaped and completely seals off the end.

In FIG. 7, the free end 16 of the dielectric sleeve 4 is similarly dome-shaped.

Where the dielectric sleeve 4 is borosilicate glass tubing or quartz or a ceramic, a slight depression 17 (see FIG. 7) can be milled around the inner electrode at both ends and the dielectric can be made to conform to the depressions to provide a seal.

Where the inner electrode is provided with an internal bore, the bore can be injected with argon on assembly and the argon allowed to leak to the interface between the dielectric and the inner electrode via pin holes 18.

The argon will occupy any irregularities at the interface and enhance corona production.

The outer surface of the inner electrode within the zone S can be roughened by various means such as knurling, chip forming, multistart threads, etching laser machining or equivalent processes.

With a view to providing multiple peaks or points to more effectively control micro-discharges emitted from the inner electrodes.

The embodiments illustrated are considered to be particularly suitable for ozone production in cool storage areas.

A corona discharge apparatus housing will also act as a heat sink and assist to dissipate heat via mounting brackets 6.

The applicants have developed an ozone system to overcome the problem of ozone and nitrogen bi-products attacking the internal workings of the generator in a confined space, including moist environments such as cold storage rooms.

This system will ensure long life and more consistent operations of the ozone.

The corona discharge generation cell is made of ozone resistant materials.

Therefore, the cell can operate in high ozone atmospheres without damage or deterioration.

To save on costs, this new design allows an electronic box to be installed outside of the treatment area protecting if from cold, moisture and particularly the ozone atmosphere which can be quite corrosive.

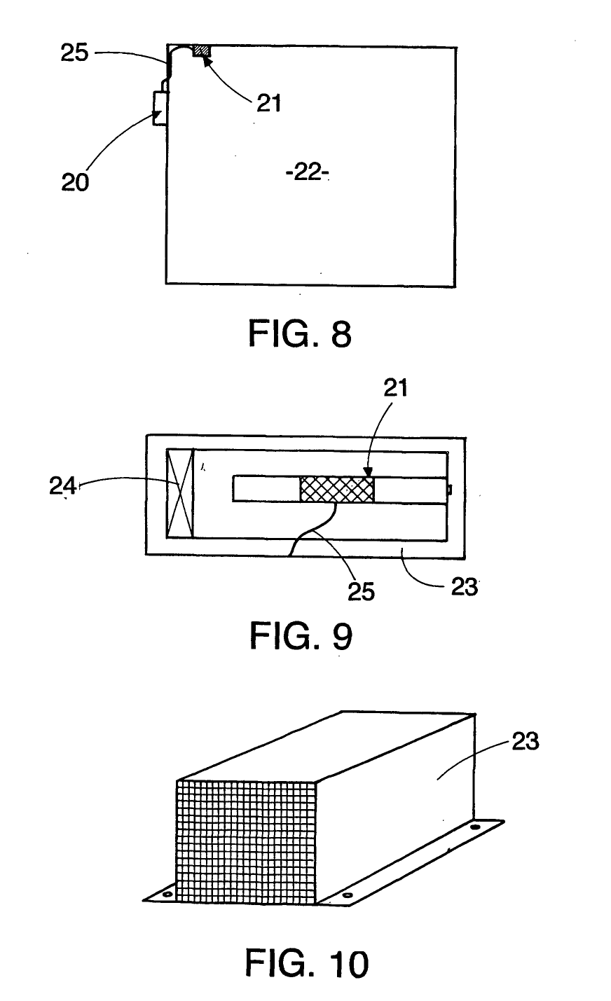

With respect to FIGS. 8 to 10 the system separates the ozone generator into two sections:

ξ an electronic unit generally indicated by arrow 20, and

ξ an ozone generation cell generally indicated by arrow 21.

The electronic unit consists of an electronic power board 20 that is mounted in a suitable enclosure with a fan for cooling and a low voltage power supply (adapter).

The electronic unit 20 is installed outside the ozone treatment area 22.

The ozone generation cell 21 (which may be corona discharge, cold plasma etc) is mounted inside the treatment area and installed in a suitable cage or enclosure 23 to protect workers from touching the cell when operating and to protect the cell from damage.

The cage or enclosure 23 is made of suitable material such as stainless steel mesh or punched steel plate to allow the free movement of air over the ozone generation cell.

In cold storage rooms, for instance, air circulation systems are generally in place to circulate the cold air.

This new ozone system design allows for the use of circulating air permitting it to pass over the reactor cell with little restriction so as to generate ozone.

The openings in the cage or enclosure 23 need to be suitably sized to prohibit someone touching the cell when operating but large enough to allow a good flow of air over the cell 21.

If there is no circulating air in the confined treatment area a fan can be installed in the cell cage or enclosure to provide the airflow.

The fan is the only item that may have some susceptibility to ozone and is not all that expensive to replace from time to time.

A small fan 24 can also be mounted in the cell cage or enclosure 23 to provide directed air flow over the cell if the circulating air in a cool room does produce maximum ozone output from the cell due to insufficient air flow passing over the cell.

Another option is to place a large circulation fan (not shown) in the treatment area.

The cell 21 is preferably be made of ozone resistant materials. When the system is used in a cold storage room the cell should also be resistant to cold and moisture.

Our cold and moisture corona discharge ozone generation cell is ideal for inclusion in this system.

It is made of cold, moisture, ozone and corrosion resistant materials.

Since the electronics unit is mounted outside the treatment area, it is not exposed to the ozone and corrosion environment. The system calls for low voltage power supply to ensure user safety.

A high voltage cable 25, suitably insulated, carries the power from the electronic unit to the cell in the treatment area.

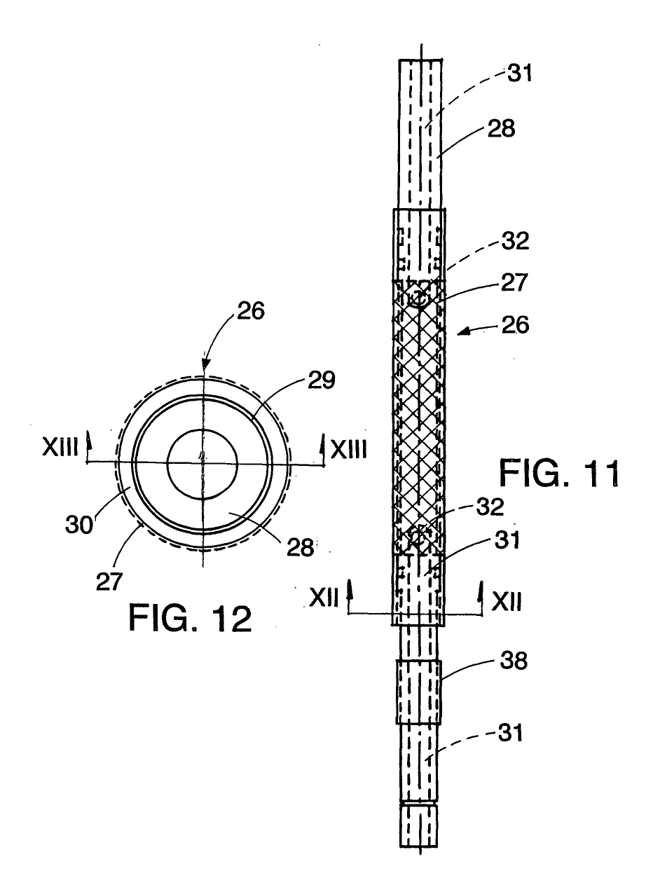

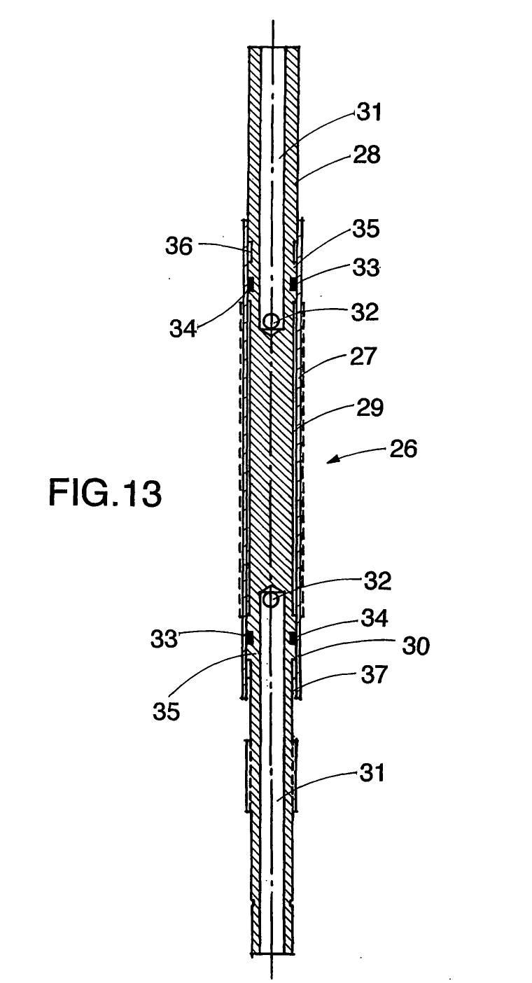

With respect to FIGS. 11 to 14 of the drawings, a further form of corona discharge apparatus is generally indicated by arrow 26 has a high voltage and zero voltage/ground electrodes 27, and 28 respectively separated by an air gap 29 and a dielectric 30.

The electrode 27 is a tubular material possibly mesh or metal sheet (which may be coated) and the electrode 28 is machined from a metal bar.

The dielectric 30 is a tubular hollow member.

The inner electrode 28 is provided two fluid passages drilled from the ends of a bar, each of the passages being communicable with an annular shaped air gap 29 created by outer walls of the electrode 28 and the inner walls of the dielectric 30.

At the inner end of the passages 31 crosswise apertures 32 provide communication to the annular air gap 29.

As with the previous embodiment seals 33 in grooves 34 provide a regular space between the electrode 28 and the dielectric 30.

It is noted that the seals 33 are spaced from the air gap 29 by bulkheads/flanges 35 created in the wall of the electrode 28.

Grooves 36 and an open region 37 provide spaces between the dielectric 30 and the inner electrode 28 and as such the opportunity to provide a permanent seal between these two elements.

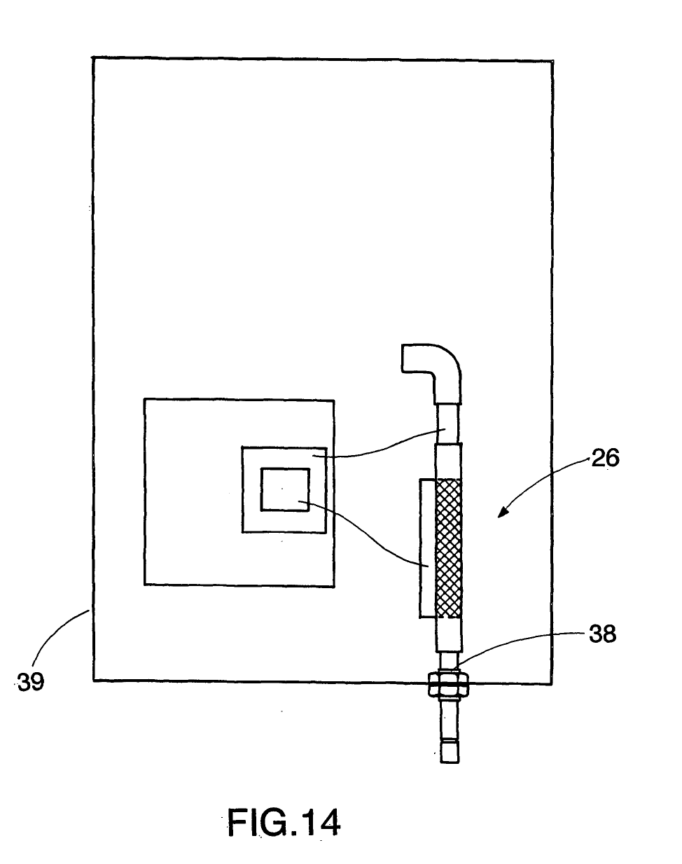

One end of the electrode 28 is provided with an external thread 38 which facilitates bolting of the apparatus to a metal control console 39 (see FIG. 14).

The balance of the outer surfaces of the inner electrode 28 may be provided with cooling fins created by threads or fluting (not shown).

The apparatus is thus grounded to the metal enclosure.

When a powder coated galvanized iron enclosure is used, the powder coating should be ground off where the nuts and possibly associated washer contact the enclosure. Additionally the contact with the metal enclosure allows for the metal enclosure to act as a large heat sink and dissipates the heat generated in the corona apparatus very effectively to ensure it operates at a very low temperature. High temperatures during operation will lower ozone production.

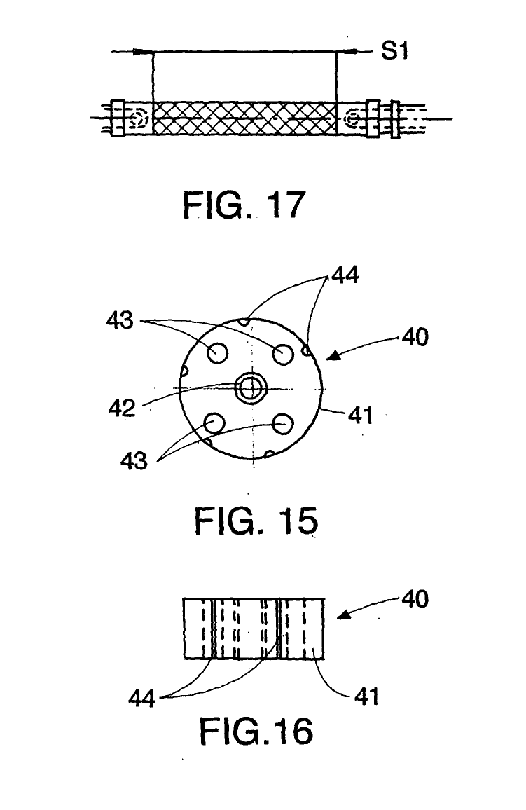

With respect to FIGS. 15 and 16 of the drawings a heat disapation device according to the present invention generally indicated by arrow 40 can comprise a disc-like body 41 provided with a plurality of apertures therein.

A central aperture 42 has an internal thread surrounding apertures 43 may be open or filled with cooling gels.

The outer edges or the body 41 can be provided with flutes 44.

The device 40 can be used as a nut to attach an inner electrode to a bulk head and has been found to greatly increase heat disapation.

With respect to FIG. 17 of the drawings a region S1 of an inner electrode has a roughed surface created by knurling, chip forming, multi-start threads, etching, laser machining or equivalent processes.

The roughed surfaces provide a multitude of peaks or points to more effectively control micro-discharges emitted from the inner electrodes.

The roughened region S1 is approximately the same length as an outer electrode and within the confines of the ozone producing zones S.

Aspects of the present invention have been described by way of example only and it will be appreciated that modifications and additions thereto may be made without departing from the scope thereof, as defined in the appended claims.

1. Corona discharge apparatus comprising:
(a) an elongate inner electrode
(b) an elongate dielectric sleeve mounted on the inner electrode,
(c) an elongate outer electrode mounted on the dielectric sleeve, and
(d) a pair of spaced sealing members between the inner electrode and the dielectric which define an ozone-producing region over which the outer electrode extends.

2. Corona discharge apparatus as claimed in claim 1 wherein the inner electrode is a metal bar.

3. Corona discharge apparatus as claimed in claim 1 wherein the inner electrode is provided with an internal bore which extends substantially throughout the ozone producing region.

4. Corona discharge apparatus as claimed in claim 1 wherein the inner electrode is provided with circular spaced circular grooves in which the sealing members are located.

5. Corona discharge apparatus as claimed in claim 1 wherein the sealing members comprise resilient O-ring seals.

6. Corona discharge apparatus as claimed in claim 3 wherein the internal bore is sealed off.

7. Corona discharge apparatus as claimed in claim 1 wherein the outer surface of the inner electrode is provided with a rough finish created by knurling, chip forming, multistart threads, etching, laser machining or equivalent processes.

8. Corona discharge apparatus as claimed in claim 1 wherein the inner electrode, dielectric sleeve and the outer electrode are cylindrical.

9. Corona discharge apparatus as claimed in claim 1 wherein the dielectric sleeve is open at one end and crimped at another end.

10. A method of generating ozone in a controlled environment comprising the steps of positioning corona discharge apparatus as claimed in claim 1 within the controlled environment and providing a connecting power source for the apparatus in a position remote from the controlled environment.

11. Corona discharge apparatus comprising;
(a) an elongate inner electrode,
(b) an elongate dielectric sleeve mounted on the inner electrode,
(c) an elongate outer electrode mounted on the dielectric sleeve,
(d) a pair of peripheral spacer members extending from the inner electrode which define an ozone producing zone over which the outer electrode extends,
(e) an air space between the inner electrode and the dielectric created by the spacers, and
(f) hollow bores extending from respective ends of the inner electrode and an outlets from each of the bores into the air space.

12. Corona discharge apparatus as claimed in claim 11 wherein the outer surface of the inner electrode between the outlets is roughened.

13. Corona discharge apparatus as claimed in claim 11 wherein at least one end of the inner electrode outside the ozone producing zone is provided with an external thread to facilitate fixture of the apparatus to a supporting wall.

14. Corona discharge apparatus as claimed in claim 11 wherein the spacers are provided in the form of resilient O-rings and/or flanges.

15. Corona discharge apparatus as claimed in claim 11 wherein the outer surfaces of the inner electrode outside the ozone producing zone are provided with cooling fins created by threads or fluting.

16. Corona discharge apparatus as claimed in claim 11 wherein the inner electrode, dielectric sleeve and the outer electrode are cylindrical.

17. Corona discharge apparatus as claimed in claim 11 wherein the inner electrode extends throughout and beyond both ends of the dielectric sleeve.

18. Corona discharge apparatus as claimed in claim 11 wherein the inner electrode is fabricated from metal bar.

19. Corona discharge apparatus as claimed in claim 12 wherein the roughed surface is created by knurling, chip forming, multistart threads etching, laser machining or equivalent processes.
